(19) United States
(12) Patent Application Publication
(10) Pub. No.: US 2013/0087740 A1
(43) Pub. Date: Apr. 11, 2013

(54) INFRARED FLUORESCENT COMPOSITION HAVING POLYVINYL ACETAL BINDER

(71) Applicants: Thomas J. Widzinski, (US); Judith A. Bose, Webster, NY (US); Thomas D. Pawlik, Rochester, NY (US); Myra Toffolon Olm, Webster, NY (US)

(72) Inventors: Thomas J. Widzinski, (US); Judith A. Bose, Webster, NY (US); Thomas D. Pawlik, Rochester, NY (US); Myra Toffolon Olm, Webster, NY (US)

(21) Appl. No.: 13/270,259

(22) Filed: Oct. 11, 2011

(51) Int. Cl. C09K 11/06; C09K 11/02

(52) U.S. Cl. 252/301.35

(57) ABSTRACT

A composition is disclosed that includes a dye that fluoresces in the infrared region of the electromagnetic spectrum and a polyvinyl acetal binder. The weight ratio of the dye relative to the combined weight of the dye and binder is in a range of 0.001 to 0.025.

### CROSS-REFERENCE TO RELATED APPLICATIONS

Reference is made to commonly assigned U.S. patent application Ser. No. ______ filed concurrently herewith, entitled “Ink Having Polyvinyl Acetal Binder”, by Thomas J. Widzinski et al, U.S. patent application Ser. No. ______ filed concurrently herewith, entitled “Article Printed With Infrared Dye”, by Thomas J. Widzinski et al, U.S. patent application Ser. No. ______ filed concurrently herewith, entitled “Compact View for Invisible Indicia”, by Thomas D. Pawlik et al, and U.S. patent application Ser. No. ______ filed concurrently herewith, entitled “Method for Viewing Invisible Indicia”, by Thomas D. Pawlik et al, the disclosures of which is incorporated herein.

### FIELD OF THE INVENTION

The present invention relates to a composition including polyvinyl acetal and infrared fluorescent dyes.

### BACKGROUND OF THE INVENTION

Inks have been used to mark items for a number of purposes, for example, for determining their authenticity or unique identification. Such markings, e.g., covert markings, may be used to identify goods that are intended for sale in a particular market. These markings are intended to prevent profit through the selling of goods for higher margins in a higher value market, where such goods were originally distributed for sale in a lower value market. Covert marking applications typically require that the markings are both invisible to the human eye and difficult to copy in the event that the marking is discovered. Such marks can be produced through careful application of dyes that exhibit useful Stokes shifts when excited with a particular wavelength of light. UV dyes, for example, when excited with UV light will often emit a human detectable emission in the visible region. Many lower cost materials that exhibit this phenomenon emit light in the blue region. This phenomenon can be useful, but has some serious drawbacks. Primarily, the ability to detect “UV marks” is quite easy because you only need a source of UV light (ubiquitous these days) and your eye, thus rendering the security of these marks as questionable. Secondarily, the effectiveness of blue emitting materials is limited, sometimes severely so if the substrate is white and has been treated with optical brighteners. Substrates treated with optical brighteners also emit blue light when excited with UV light thus making the contrast between substrate and mark difficult if not impossible to determine.

IR dyes have the benefit of excitation and emission in the infrared region. Without the aid of a carefully constructed viewing device, IR emission is not detectible to the human eye. A major drawback of these systems is that by their nature IR dyes are not particularly lightfast. Many efforts have been made to improve dye stability through dye structure manipulation and through favorable formulation development, i.e., inclusion of stabilization addenda.

It is known that inks for printing generally include a vehicle or solvent, a colorant (dye or pigment), a binder material (that affixes the colorant in place once the vehicle is adsorbed or evaporates) and other addenda that are specific to the printing methodology in use. In the case of solvent-based continuous inkjet printing, the vehicle can be a combination of organic solvents, the colorant (a dye or pigment depending on the equipment design and substrate requirements), a binder material (generally a polymer having sufficient solubility, viscosity, solvent release and binding properties), and conductivity control material (to enable sufficient charging of discrete ink droplets) and other addenda that enhance overall ink performance.

Polymethine (cyanine) dyes are one class of several possible classes that are nicely soluble in a variety of continuous inkjet printing systems and exhibit good fluorescence quantum yield. However most IR dyes, including polymethine dyes, are susceptible to undesired reactions leading to their possible depletion before an inks' desired lifetime has expired.

IR dyes are generally dark green to black when dissolved in solvent. It is a requirement that the dye be invisible to the eye when printed in the form of an ink (low or no stain). When printed, IR dyes can be visualized in an absorptive or emissive mode. Greater selectivity, and thus security, is enjoyed when the dyes are visualized in the emissive mode. This necessitates that the viewing device be constructed such that the excitation and emission wavelengths be sufficiently separated so that only the dye emission is detected and displayed.

Given the above requirements, one must consider solution stability. Low concentrations of dye that can be susceptible to various decomposition pathways necessitate that careful attention be paid to the constituents of an ink formulation.

U.S. Pat. No. 5,093,147 discloses infrared fluorescing inks which are useful for printing invisible markings on the surface of an article. The inks use known polymethine (cyanine) laser dyes. Although the dyes used provide invisible markings, the cyanine dyes, unfortunately, have the disadvantage of fading or decomposing upon brief exposure to ultraviolet light.

Dye stabilization has been described in the art. Mitsubishi Kasai (EP 0 483 387 A1) and TEK Corp. (U.S. Pat. No. 4,713,314) describes the use of cyanine dyes combined with metal stabilizers. Nickel formazan dyes have been described by Eastman Kodak as stabilizers for infrared dyes (U.S. Pat. No. 5,547,728).

It is known that near IR emissive dyes are susceptible to decomposition and that structural variation of the dye itself as well as the inclusion of protective addenda can lead to improved results. The improvements are expensive and research intensive. A simpler solution for formulating high stability IR-emitting inks is desired.

### SUMMARY OF THE INVENTION

In accordance with the present invention there is provided: a composition, comprising a dye that fluoresces in the infrared region of the electromagnetic spectrum and a binder including a polyvinyl acetal.

In another aspect of the present invention, there is provided a composition, comprising a dye that fluoresces in the infrared region of the electromagnetic spectrum and a binder including polyvinyl acetal, wherein the weight ratio of the dye relative to the combined weight of the dye and binder is in a range of 0.001 to 0.025.

Advantages of the present invention is that polyvinyl acetal based binders permit much higher dye stability and enables the use of dye mixtures having superior stability relative to other binders.

### DETAILED DESCRIPTION OF THE INVENTION

The present invention provides, in an embodiment, an ink composition suitable for ink jet printing, including a dye that fluoresces in the near-infrared region (700 nm to 1200 nm) of the electromagnetic spectrum and a binder of the polymer class of polyvinyl acetals. Commercially available classes of polyvinyl acetals include PVF (polyvinyl formal) and PVB (polyvinyl butyral). These materials are synthesized from polyvinyl acetate of various mw (molecular weight) ranges that has been partially or completely saponified to polyvinyl alcohol of corresponding chain length and is further converted to the acetal (formal or butyral) by reaction with the corresponding aldehyde. Composition of the PVF or PVB varies depending on the mw range of the starting polyvinyl acetate as well as the degree of saponification and degree of acetalization. Useful molecular weight ranges can vary from 20,000 to 250,000 mass units. The molecular weight is in a range from 20,000 to 80,000 mass units. Residual polyvinyl acetate typically ranges from 0 to 5%, residual hydroxyl groups, in the form of polyvinyl alcohol, typically varies from 10-30%. The residual hydroxyl groups are in a range from 15-25%. Degree of acetalization typically varies from 70 to 90%. The degree of acetalization is in a range from 75-85%.

The composition of near infrared fluorescing dye and polyvinyl acetal binder are combined in a weight ratio of the dye relative to the combined weight of the dye and binder is in a range of 0.001 to 0.025. Ratios less than 0.001 are generally insufficient for dye detection while ratios above 0.025 interfere with fluorescence quantum yield due to self quenching. A preferred range is 0.007 to 0.025. A more preferred range is 0.01 to 0.02 as it maximizes fluorescence quantum yield of dye in the printed ink and enables a robust formulation with regard to both manufacturing variability solution shelf life.

A useful near infrared fluorescing dye structural class for this composition is described by Structure I:

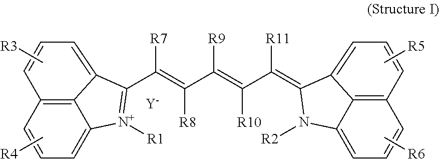

wherein R1 and R2 are each independently selected alkyl groups having 1 to 16 carbon atoms;

R3, R4, R5, and R6 are independently selected from hydrogen, alkyl, alkenyl, aryl, halo, cyano, alkoxy, phenoxy, ester, amide, amine, cyano, ketone, sulfide, sulfoxide, sulfone, sulfonate, sulfonamide, carboxylate nitro, or a polymeric moiety;

R7, R8, R10 and R11 are independently selected from hydrogen or alkyl;

R9 is selected from hydrogen, halogen, aryl, sulfide, sulfoxide, sulfone, amine, a heterocyclic moiety, phenoxide, alkoxide or cyano; and

Y⁻ is an anion.

Non limiting examples of useful anions for Y⁻ include bromide, chloride, iodide, p-tosylate, tetrafluoroborate, hexafluorophosphate, trifluoromethanesulfonate, toluene sulfonate heptafluorobutyrate, trifluoroacetate, perchlorate, and stearate. Y⁻ can optionally be an anioinic moiety that is covalently attached to Structure I. When covalently attached, Y⁻ is preferably a sulfonate or carboxylate group.

Any of the substituents mentioned above, other than hydrogen, cyano and halogen can optionally be further substituted with halogen, alkoxy, ester, amide, amine, cyano, ketone, sulfide, sulfoxide, sulfone, sulfonate, sulfonamide, hydroxyl, ether, carbamate or carboxylate functional groups.

R3, R4, R5, or R6 can optionally form a ring structure with the aromatic structure to which it is attached. Alkyl groups can be straight chained, branched or cyclic.

Some examples of useful infrared dyes are shown below

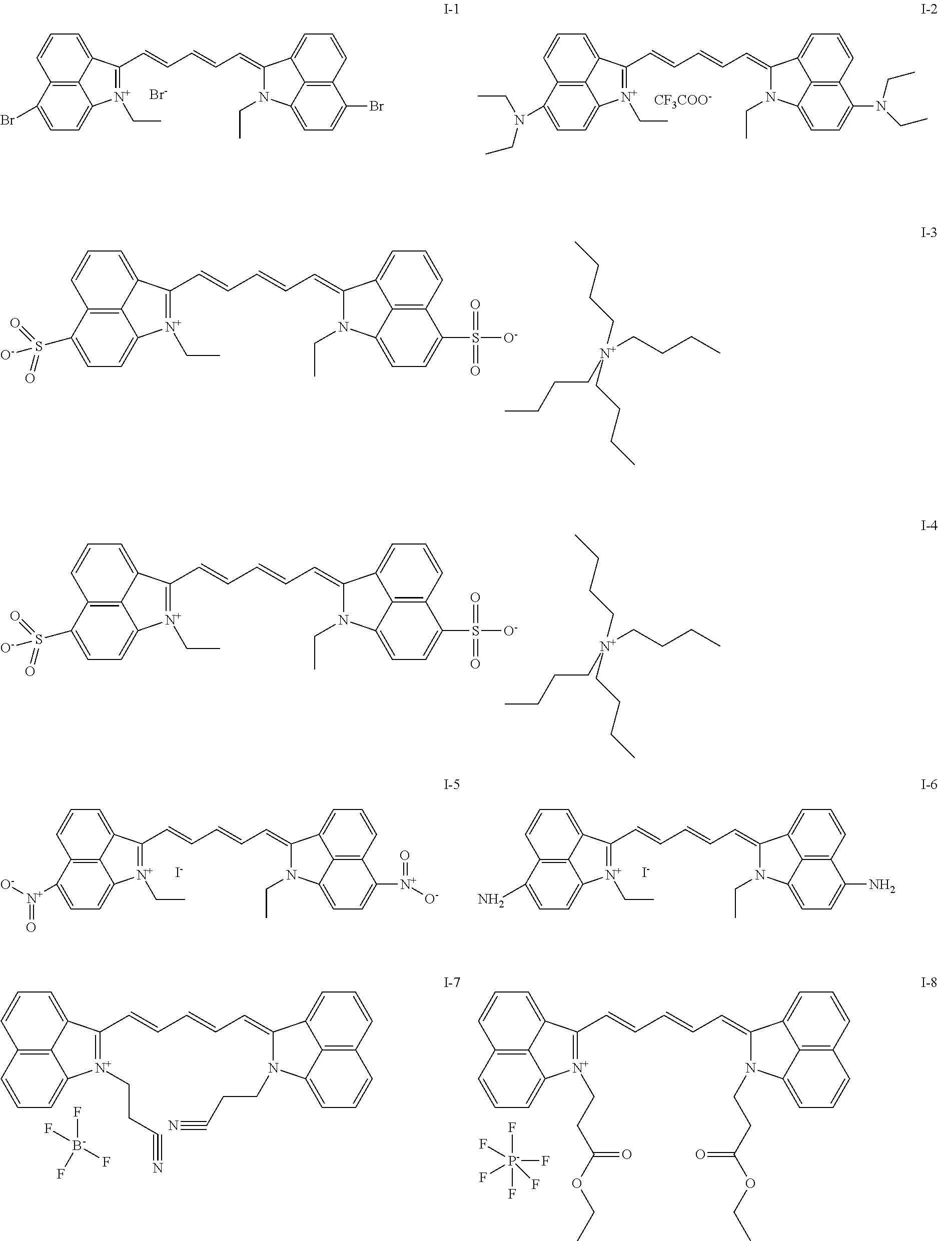

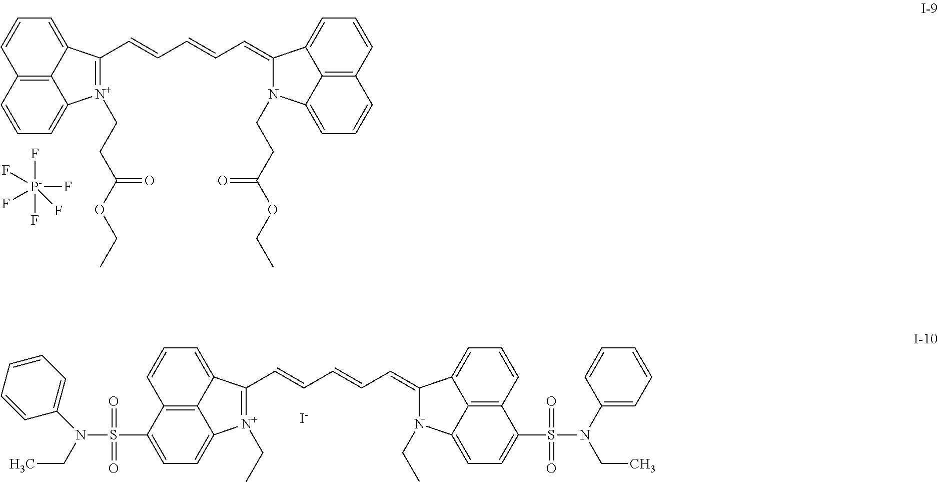 [SMILES: CCOC(=O)CCn1\c(=C/C=C/C=C/C2=[N+](CCC(=O)OCC)c3cccc4cccc2c34)c2cccc3cccc1c32 ; F[P-](F)(F)(F)(F)F ; CCN(c1ccccc1)S(=O)(=O)c1ccc2c3c(cccc13)C(/C=C/C=C/C=c1/c3cccc4c(S(=O)(=O)N(CC)c5ccccc5)ccc(c43)n1CC)=[N+]2CC ; [I-]]

In a preferred embodiment of Structure I, R3 through R11 are selected to be hydrogen, as shown in Structure Ia.

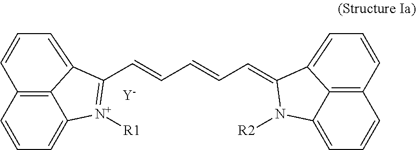

Examples of useful infrared fluorescing dyes of Structure Ia include the following:

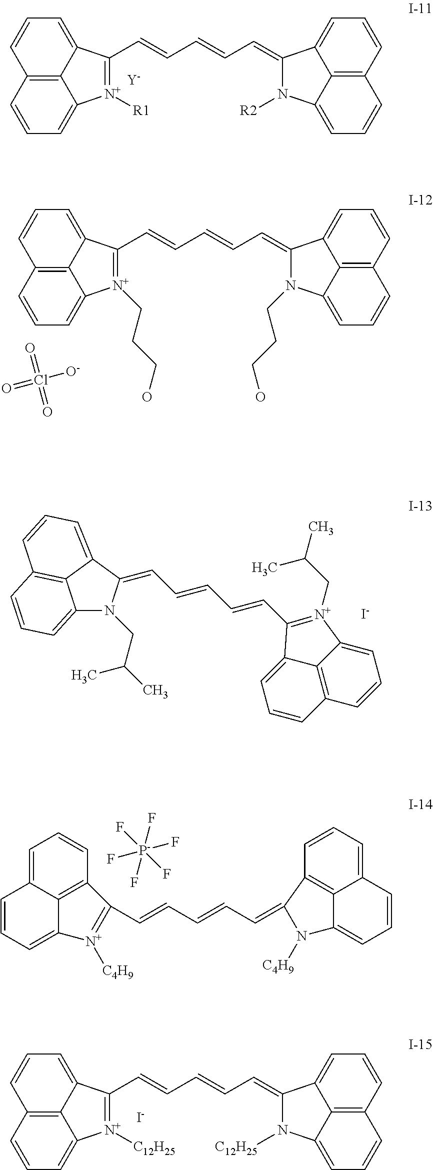

An additional useful near infrared fluorescing dye structural class for this composition is described by Structure II.

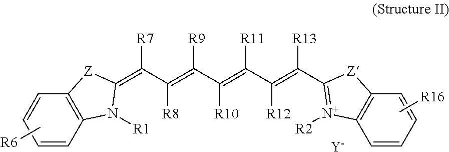

wherein R1 and R2 are independently selected alkyl groups having 1 to 18 carbon atoms;

Z and Z′ are independently selected from —O—, —S—,

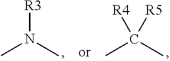

wherein R3, R4 and R5 are independently selected alkyl groups;

R7, R8, R9, R10, R11, R12 and R13 are independently selected from hydrogen, alkyl, amine, aryl, sulfone, triazole or halo;

R6 and R16 are independently selected from hydrogen, alkyl, alkenyl, aryl, fused aryl, halo, cyano, alkoxy, phenoxy, ester, amide, amine, nitrile, ketone, sulfide, sulfoxide, sulfone, sulfonate, sulfonamide, carboxylate nitro, or a polymeric moiety; and

Y⁻ is an anion.

Non limiting examples of useful anions for Y⁻ include bromide, chloride, iodide, p-tosylate, tetrafluoroborate, hexafluorophosphate, trifluoromethanesulfonate, toluene sulfonate heptafluorobutyrate, trifluoroacetate, perchlorate, and stearate. Y⁻ can optionally be an anioinic moiety that is covalently attached to Structure II. When covalently attached, Y⁻ is preferably a sulfonate or carboxylate group.

Any of the substituents mentioned above, other than hydrogen, cyano and halogen can optionally be further substituted with halogen, alkoxy, ester, amide, amine, nitrile, ketone, sulfide, sulfoxide, sulfonate, sulfonamide, hydroxyl, ether, carbamate or carboxylate functional groups.

R6 or R16 can optionally form a ring structure with the aromatic structure to which it is attached. R9 and R11, or R8 and R10, or R10 and R12 can optionally be fused to form a 5 or 6 member ring structure. Alkyl groups can be straight chained, branched or cyclic. R3, R4 and R5 preferably have 1 to 4 carbon atoms

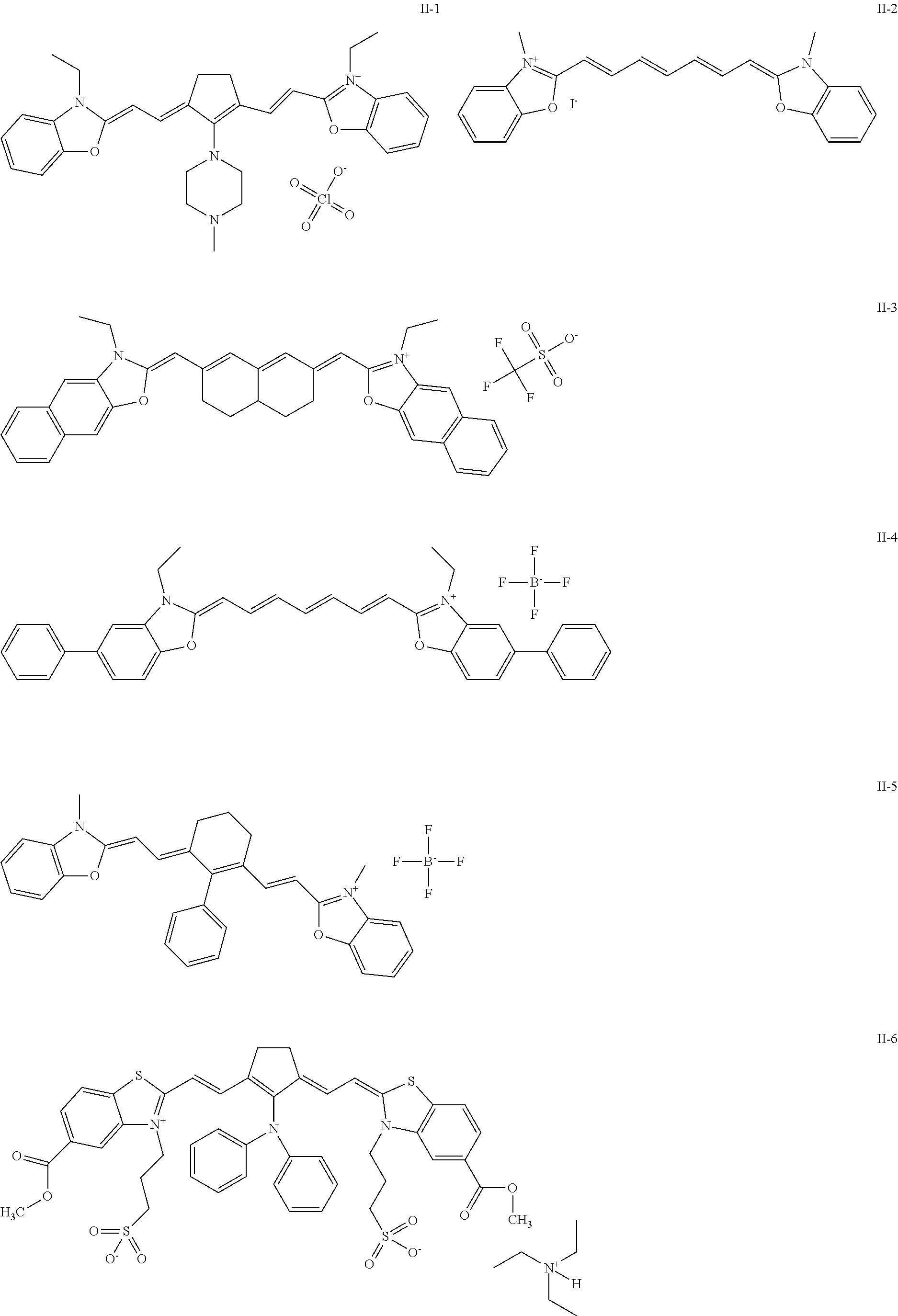

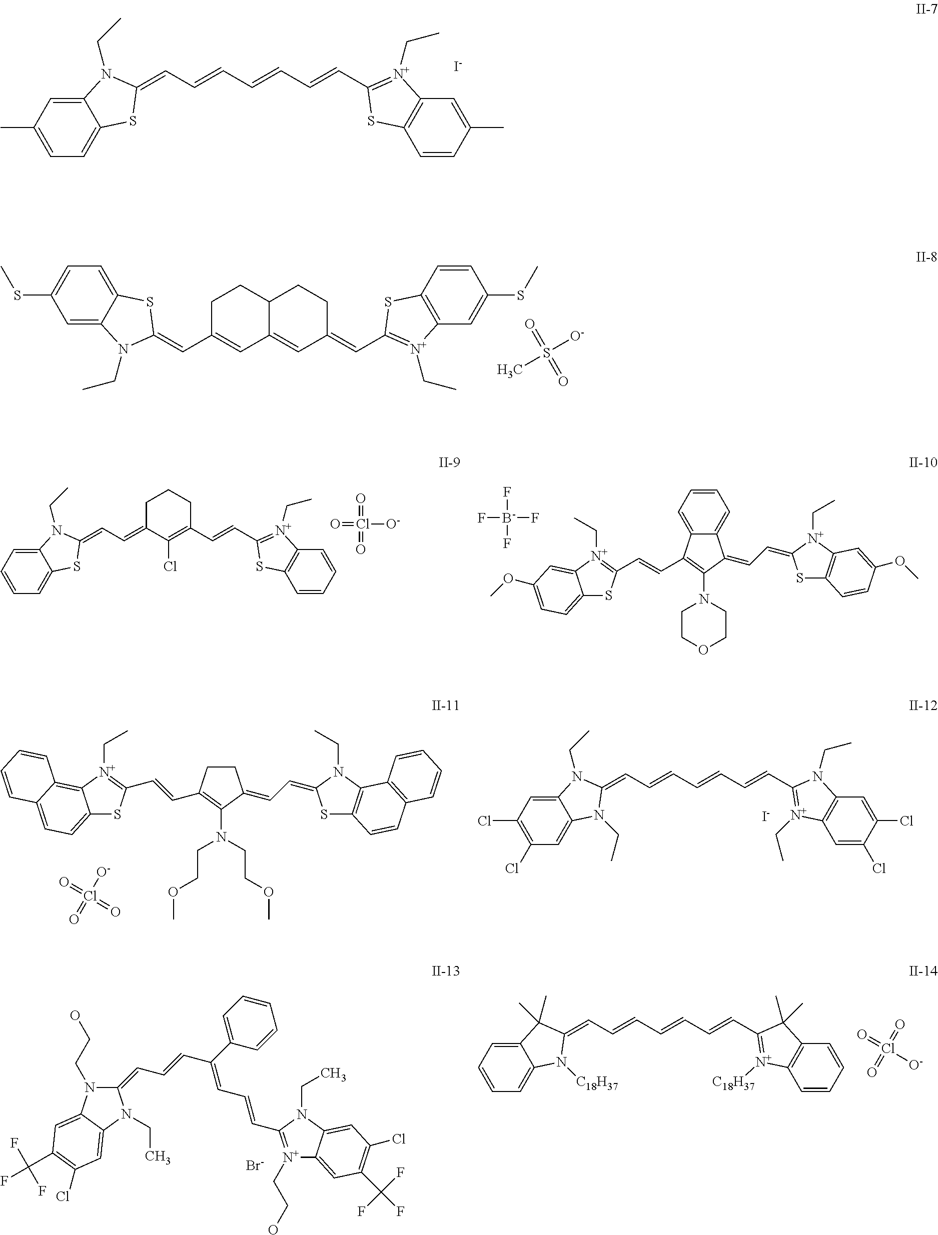

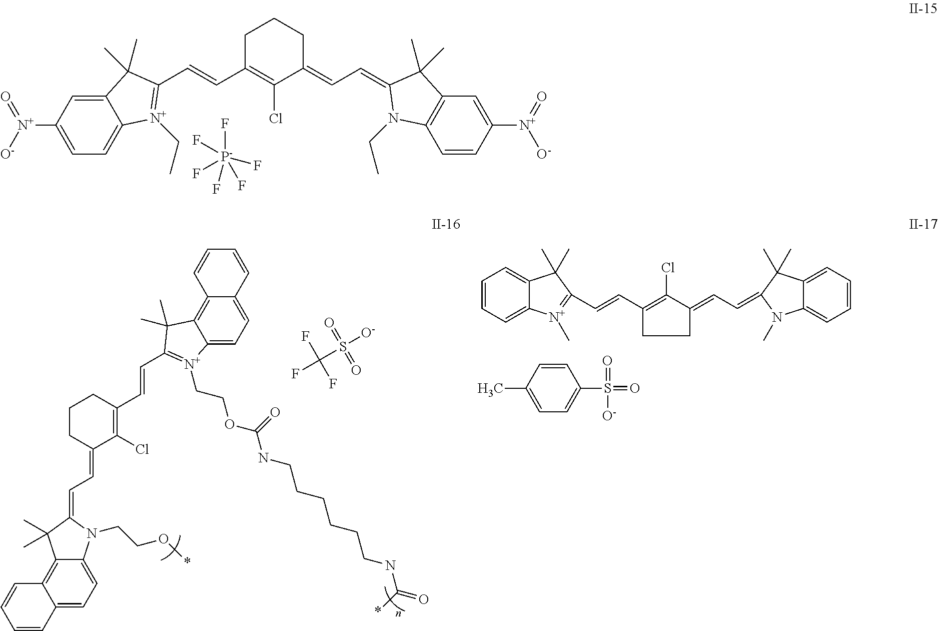

A preferred embodiment of Structure II is shown in Structure IIa:

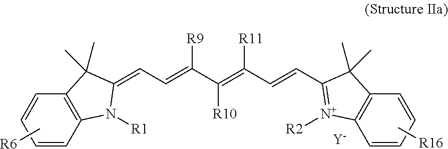

wherein R6 and R16 are the same; R1 and R2 are the same; R9 and R11 form a carbocycle of either 5 or 6 carbons and R10 is a halogen, benzenesulfiniate, N,N diphenyamine or triazole.

Examples of infrared fluorescing dyes within the above formula include the following:

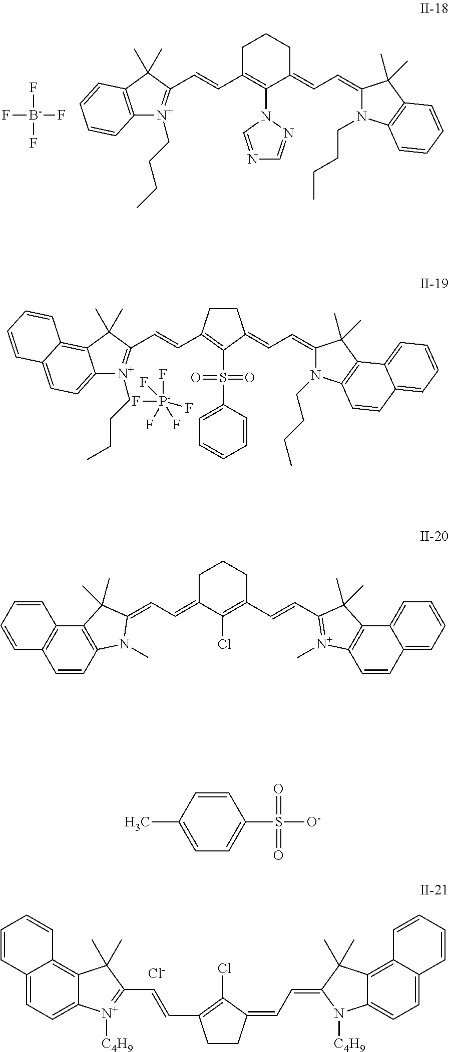

An additional useful near infrared fluorescing dye structural class for this composition are phthalocyanines

Preferred phthalocyanines are shown by Structure III

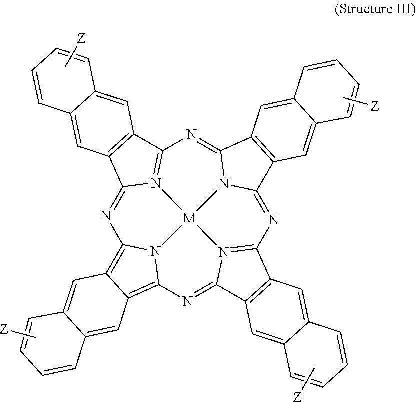

wherein Z is independently selected from hydrogen, alkyl, alkenyl, aryl, halo, cyano, alkoxy, aryloxy, ester, ether, amide, amine, cyano, ketone, sulfide, sulfoxide, sulfone, nitro, or a polymeric moiety;

at least one Z is other than hydrogen; and

M is 2H, vanadium oxide, zinc, aluminum chloride, silicon oxide, or magnesium.

Z is preferably selected to enhance solubility in the solvent. Examples of particularly useful infrared fluorescing dyes within the above formula include the following:

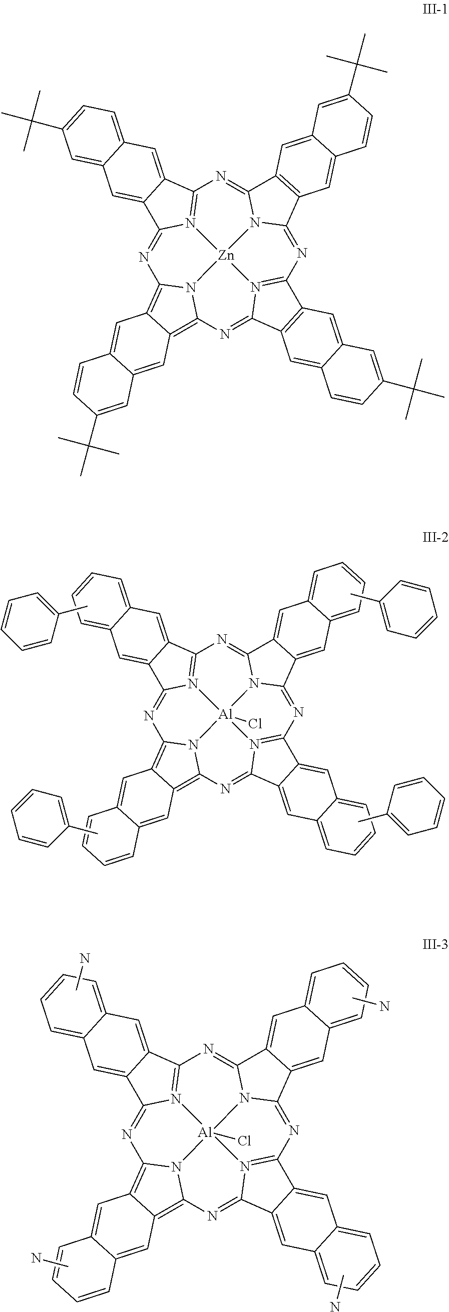

An additional useful near infrared fluorescing dye structural class for this composition is described by Structure IV:

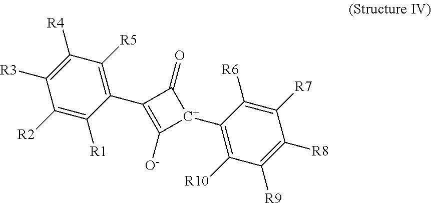

wherein R1, R2, R3, R4, R5, R6, R7, R8, R9 and R10 are independently selected from hydrogen, alkyl, aryl, heteroaryl, halogen, amino, mercapto, hydroxyl, aryloxy or alkoxy.

R1 and R2, or R2 and R3, or R6 and R7, or R7 and R8 can independently form an aromatic or heterocyclic ring structure. Any of the substituents mentioned above, other than hydrogen and halogen can optionally be further substituted with halogen, alkoxy, ester, amide, amine, cyano, ketone, sulfide, sulfoxide, sulfone, sulfonate, sulfonamide, hydroxyl, ether, carbamate or carboxylate functional groups. Alkyl groups can be straight chained, branched or cyclic.

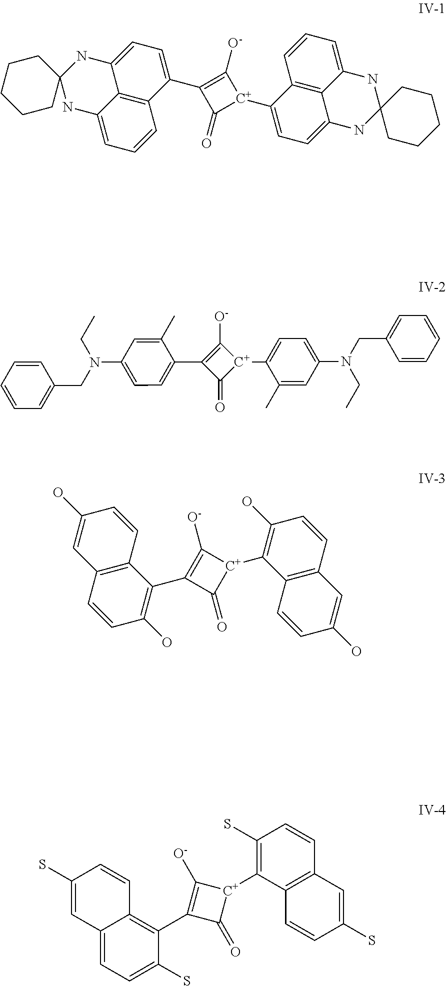 [SMILES: O=c1c(-c2ccc3c4c(cccc24)NC2(CCCCC2)N3)c([O-])[c+]1-c1ccc2c3c(cccc13)NC1(CCCCC1)N2 ; CCN(Cc1ccccc1)c1ccc(-c2c([O-])[c+](-c3ccc(N(CC)Cc4ccccc4)cc3C)c2=O)c(C)c1 ; O=c1c(-c2c(O)ccc3cc(O)ccc23)c([O-])[c+]1-c1c(O)ccc2cc(O)ccc12 ; O=c1c(-c2c(S)ccc3cc(S)ccc23)c([O-])[c+]1-c1c(S)ccc2cc(S)ccc12]

In a more preferred embodiment of the invention, the infrared fluorescing dye has Structure IVa:

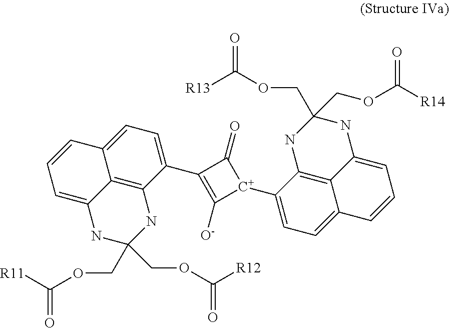

wherein R11, R12, R13 and R14 are independently selected from alkyl groups having 1 to 15 carbon atoms or aryl having 6 to 10 carbons. Such alkyl or aryl groups can optionally be further substituted with halogen, alkoxy, ester, amide, amine, cyano, ketone, sulfide, sulfoxide, sulfone, sulfonate, sulfonamide, hydroxyl, carbamate or carboxylate functional groups.

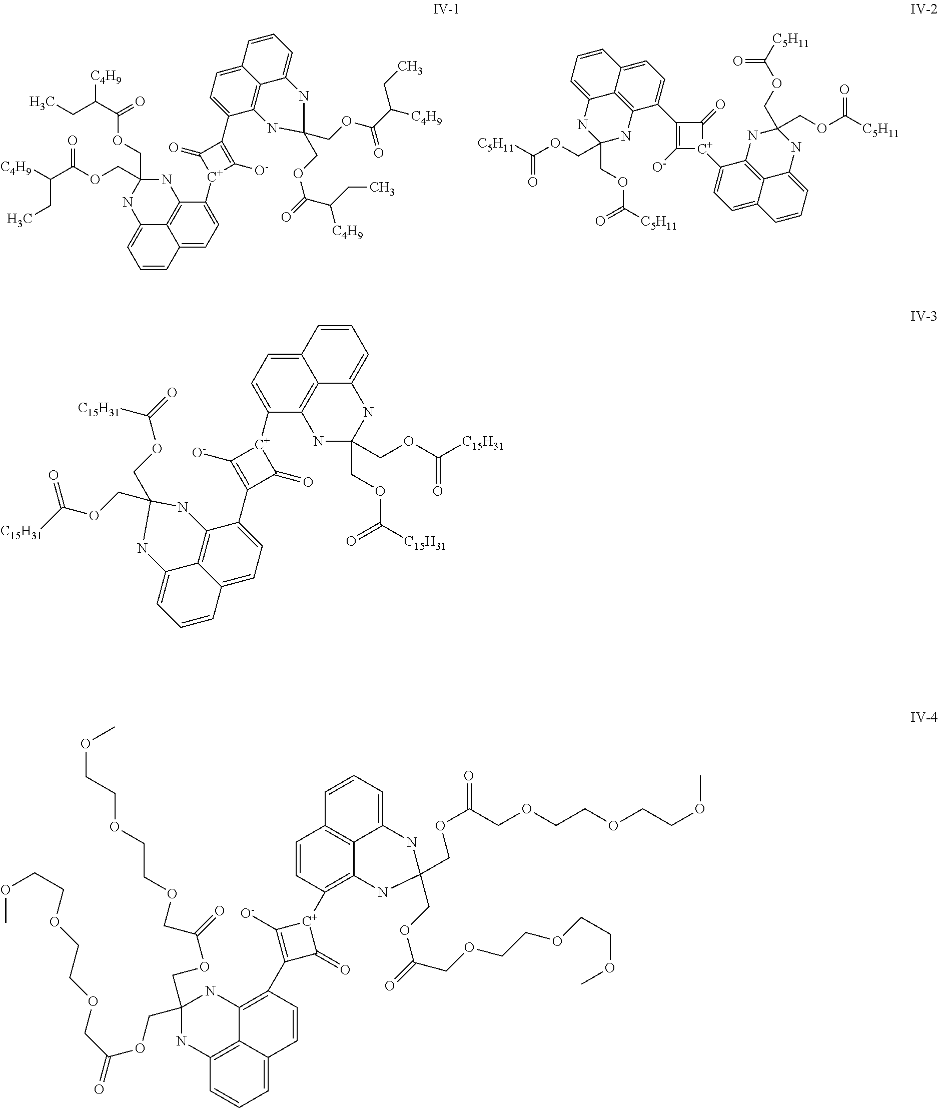

An additional useful near infrared fluorescing dye structural class for this composition is described by Structure V.

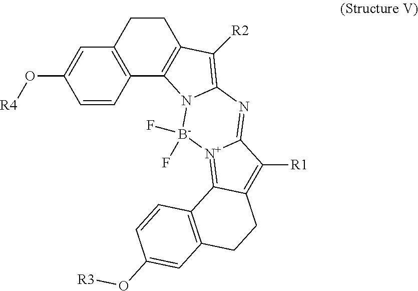

wherein R1 and R2 are independently selected aromatic rings; and

R3 and R4 are independently selected alkyl having 1 to 18 carbon atoms or aryl having 6 to 10 carbons.

Any of the substituents R1 through R4 can optionally be further substituted with halogen, alkoxy, ester, amide, amine, cyano, ketone, sulfide, sulfoxide, sulfone, sulfonate, sulfonamide, hydroxyl, ether, carbamate or carboxylate functional groups. Alkyl groups can be straight chained, branched or cyclic.

Examples of infrared fluorescing dyes within the above formula include the following:

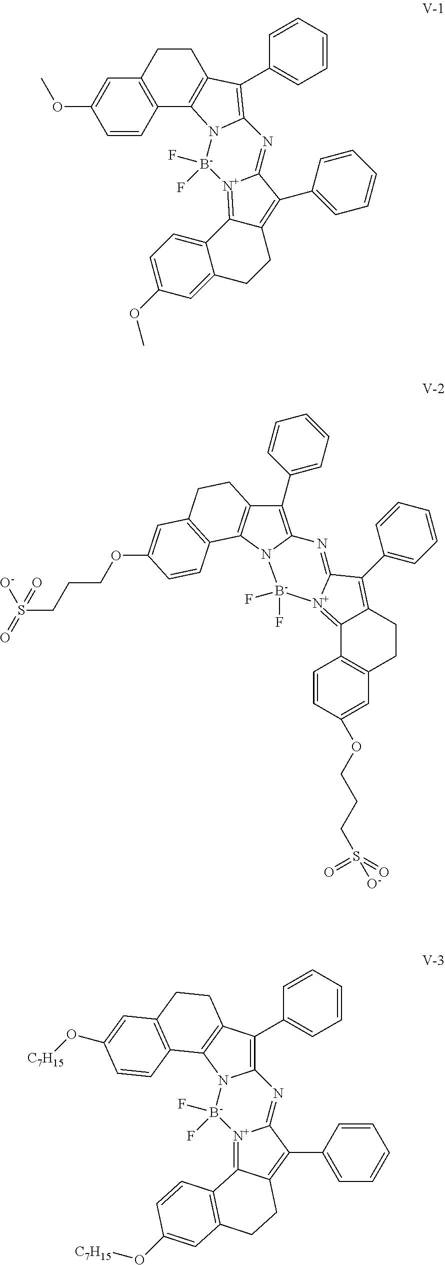

Dye and binder combinations can include a single dye and binder, or multiple dyes with a single or multiple binders. Particularly useful combinations include a dye from the type described by Structure I and a dye from the type described by Structure II. Dyes of structure II typically have higher relative stability, but lower relative fluorescence quantum yield as compared with selected dyes from the Structure II class. High quantum yield dyes, such as those from Structure II, appear bright in a detecting or viewing device and can be useful for immediate reading where a strong emission signal is important. On the other hand, an intrinsically more stable dye, such as those described by Structure I exhibit lower quantum yield but is useful for forensic analysis of aged samples. The combined matching of dyes with polyvinylacetal binders, especially polyvinyl butyral, significantly increases the useful fluorescence life of both dye classes.

A covert invisible infrared fluorescing ink suitable for inkjet printing includes:

a solvent or solvent mixture (preferably a non-aqueous solvent such as ketone or alcohol mixtures, for example acetone, methylethyl ketone, methanol, ethanol, iso-propanol and the like);

a polymeric binder that is sufficiently soluble in the solvent mixture, imparts desired viscosity to the ink (for example, around 2.0 centipoise) and adheres the dye to the substrate once the solvent evaporates (in this case a polyvinyl acetal);

solvent stabilizers such as hydroquinone derivatives or ascorbic acid, a dye that fluoresces in the 700 to 1200 nm region of the electromagnetic spectrum and that is sufficiently soluble in the solvent mixture.

For certain ink jet technologies, the ink can also contain a conductivity modifier such that droplets formed by the printer can accept a charge and have their trajectory precisely altered by a variable electric field produced in the print nozzle.

When considering dye concentrations in an ink, a useful range of dye concentration is 0.00005 to 0.0005 moles/liter. A more preferred range is 0.0001 to 0.0004 moles/liter. When considering binder concentrations in an ink, a useful range is 20 to 50 grams/liter. A more preferred range using preferred polyvinyl butyral is 25 to 35 grams/liter. A useful concentration range for solvent stabilizers such as hydroquinone derivatives is 0.0006 to 0.006 moles/liter.

### EXAMPLES

### Dye Synthesis

### Synthesis of a Benz (c,d) Indolium Polymethine Dye

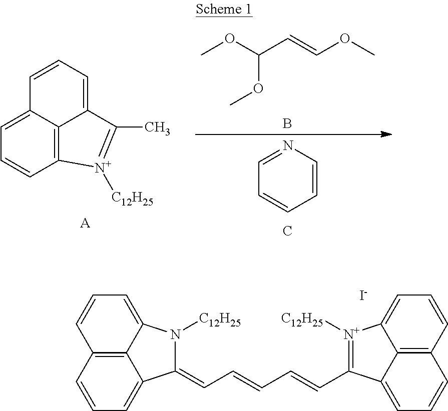

Dyes of this class were generally synthesized according to Scheme 1 shown above. For example, 2-methyl-3-N-dodecyl-benz (c,d) indolium iodide A (40 g, 0.086 mole) was heated with 1,3,3-trimethoxyprop-1-ene B (15 g, 0.11 mole) in the presence of pyridine 500 mL to mild reflux for 5 minutes. Quench the reaction by pouring into 4 liters of vigorously stirred ice water. The product is extracted into 700 mL dichloromethane then precipitated by addition of 2 liters methanol. Product is collected in a suction funnel, washed with methanol and dried under vacuum at 45 degrees C. Yield is 12 g, or 60% of theoretical.

### Synthesis of a Benz (e) Indolium Heptamethine Cyanine Dye

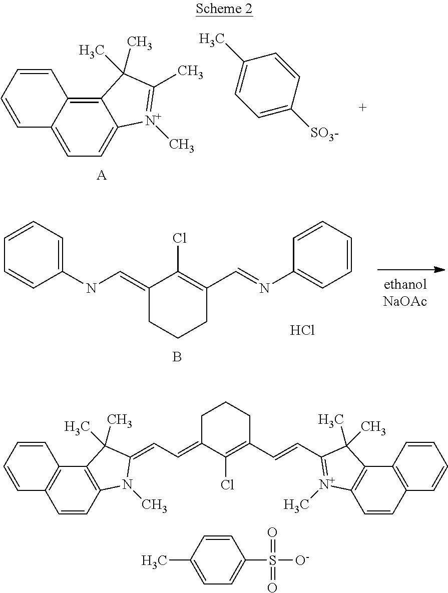

A solution of the benz (e) indole A (15 g, 0.038 mol), dianil salt B (6.8 g, 0.019 mol) and sodium acetate (4.1 g, 0.05 mol) are stirred in ethanol (375 mL) at gentle reflux for one hour. Ethanol is evaporated and the resulting crude dye is purified via silica gel column chromatography (eluting solvents; chloroform:methanol 19:1) to obtain pure dye. Yield is 11.8 g or 82% of theoretical.

### Synthesis of a Naphthalocyanine Structure

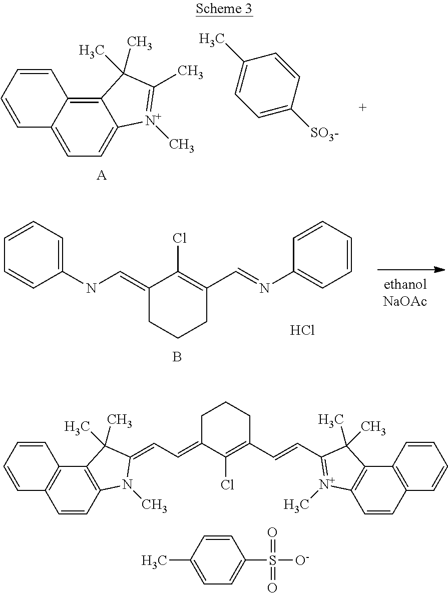

A mixture of 6-tert-butyl-2,3-dicyanonaphthalene A (18.8 g, 0.08 mol), anhydrous zinc acetate B (3.7 g, 0.02 mol), dry quinoline 100 mL and DBU 12 mL was stirred at 180 deg C. for 20 hr. After cooling, the mixture was poured into methanol (3500 mL). The crude product was collected by vacuum filtration, washed with methanol and purified by Soxhlet extraction with methanol for 2 days. Finally, the dark green residue was chromatographed on silica gel with chloroform as the eluting solvent. Chloroform was evaporated and product triturated with methanol, again collected by filtration and vacuum dried at 70 deg C. Yield was 9 g or 45% of theoretical.

### Synthesis of a Squarine Structure

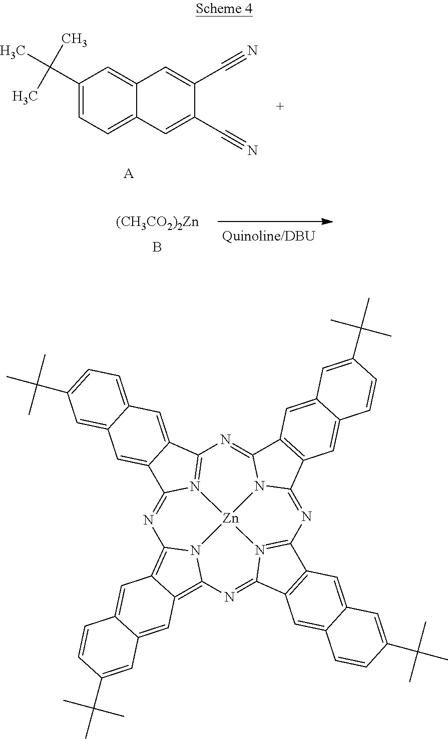

A mixture of the perimidinylide diester A (23.4 g, 0.05 mol), squaric acid B (3.1 g, 0.027 mol), n-butanol (150 mL) and heptanes (150 mL) is heated to boiling. Water resulting from the dye condensation is azeotroped over 4 hours then cooled to room temperature. The squarine dye precipitates and is collected by vacuum filtration, washed with heptanes then vacuum dried at 50 deg C. Yield is 12 g or 51% of theoretical.

### Synthesis of an Aza-BODIPY Structure

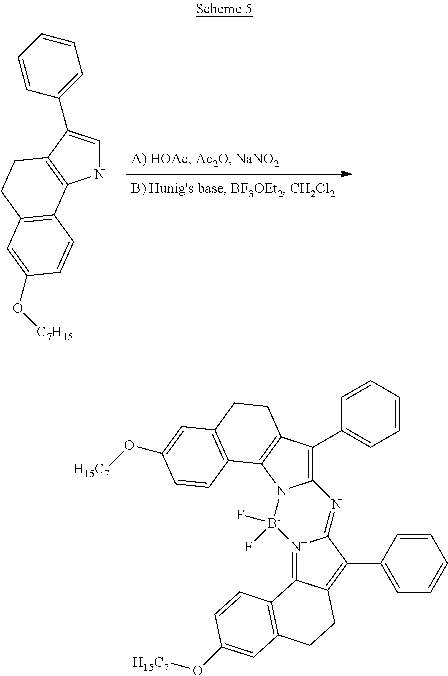

Sodium Nitrite (6.9 mg, 0.1 mmol) was added at 5 deg C. with stirring to a solution of pyrrole derivative (72 mg, 0.2 mmol), in a mixture of acetic acid/acetic anhydride (1 mL/0.4 mL). The mixture was stirred for 0.5 hr, followed by heating at 80 deg C. for 0.5 hr. Crushed ice was added to the cold reaction mixture and the blue dye was collected by vacuum filtration and washed with water. Purification was accomplished by dissolution in dichloromethane and filtration through a pad of alumina with dichloromethane rinse. Solvent was evaporated in vacuum and the residue dissolved in 1,2-dichloroethane, triethylamine (0.24 mmol) and followed by slow addition of BF3 etherate (0.24 mmol) with stirring at room temperature. Reaction proceeded for 0.5 hr, followed by heating at 80 deg C. for 0.5 hr, then cooled and quenched with crushed ice. Product was extracted with dichloromethane, again filtered through a pad of alumina, and solvent evaporated. Residue was recrystallized from dichloromethane/heptanes 1:1 and dried under vacuum. A coppery solid was obtained with a yield of 35 mg or 45% of theoretical.

### EXAMPLES

### Ink Formulations

A time dependent comparison of fluorescence for several dye classes as a function of polymeric binders was conducted. In addition to polyvinyl butyral of the present invention, other common binders were tested as comparative examples, including cellulose acetate propionate, polyurethane, polystyrene/acrylate co-polymer, polymethyl methacrylate, and polyvinyl acetate. A matrix of dye and binder combinations dissolved in the preferred concentration range in a solvent system of 95 wt % methyl ethyl ketone and 5% ethanol. Aliquots of the solutions were deposited on uncoated white cardboard in 0.002 micro liter droplets using a Hamilton #7001 microliter syringe. Groups of drops were deposited all in a row. Multiple rows were “printed” with each row representing a different polymeric binder for a given dye.

Imaging and initial scoring of fluorescence was accomplished by capturing a digital image of the fluorescence emitted by the dye when excited by shorter wavelength light, then measuring the emission intensity, or grayscale of the emission image using Image J software (Public domain software produced by the National Institute of Health, V-1.38 http://rsb.info.nih.gov/ij/ used for image analysis). Samples were then positioned within 1 cm and exposed to unfiltered light emitted from a 34 watt fluorescent tube for 66 hours. Again, emission was quantified by capturing a fluorescence image of the same spots and calculating fluorescence intensity in Image J. A comparison of exposed to initial values yields a percentage of initial intensity. A summary table, Table 1 is presented here:

TABLE 1
Fluorescence emission intensity after 66 hours light exposure
(% relative to initial emission)

| Structure | PVB | PMM | PS/Acr | CAP | PU | PVAc | None* |
|---|---|---|---|---|---|---|---|
| I-15 | 97 | 79 | 0 | 59 | 32 | 60 | 33 |
| II-20 | 100 | 77 | 17 | 27 | 60 | 57 | 27 |
| II-18 | 100 | 100 | 47 | 84 | 91 | 90 | 49 |
| II-19 | 98 | 96 | 24 | 43 | 48 | 92 | 48 |
| II-6 | 70 | 16 | 0 | 0 | 13 | 19 | 14 |
| III-1 | 93 | 47 | 0 | 37 | 22 | 35 | 49 |
| IV-2 | 98 | 96 | 24 | 43 | 48 | 92 | 48 |
| V-3 | 79 | 76 | 39 | 66 | 26 | 64 | 30 |

Where:
PVB = polyvinyl butyral
PMM = polymethyl methacrylate
PS/Acr = polystyrene acrylate co-polymer
CAP = cellulose acetate propionate
PU = polyurethane
PVAc = polyvinyl acetate
None = dye in solvent with no binder
*Emission values without binder are generally lower at T0 than when dye is dispersed in polymeric binder.

Table 1 clearly shows the unexpected fluorescence stability advantage of PVB as a binder across all classes of dyes. In a few cases, PMM also showed comparable stability, but not across all classes. Use of polyvinyl acetal based binders permit much higher stability for specific dye classes and enables the use of dye mixtures having superior stability relative to other binders, due to the unexpected general effect PVB has on stability.

The invention has been described in detail with particular reference to certain preferred embodiments thereof, but it will be understood that variations and modifications can be effected within the spirit and scope of the invention.

1. A composition, comprising a dye that fluoresces in the infrared region of the electromagnetic spectrum and a binder including a polyvinyl acetal.

2. A composition, comprising a dye that fluoresces in the infrared region of the electromagnetic spectrum and a binder including polyvinyl acetal, wherein the weight ratio of the dye relative to the combined weight of the dye and binder is in a range of 0.001 to 0.025.

3. The composition of claim 2, wherein the dye has a structure according to Structure I 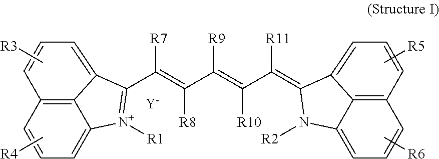
wherein R1 and R2 are each independently selected alkyl groups having 1 to 16 carbon atoms;
R3, R4, R5, and R6 are independently selected from hydrogen, alkyl, alkenyl, aryl, halo, cyano, alkoxy, phenoxy, ester, amide, amine, cyano, ketone, sulfide, sulfoxide, sulfone, sulfonate, sulfonamide, carboxylate nitro, or a polymeric moiety;
R7, R8, R10 and R11 are independently selected from hydrogen or alkyl;
R9 is selected from hydrogen, halogen, aryl, sulfide, sulfoxide, sulfone, amine, a heterocyclic moiety, phenoxide, alkoxide or cyano; and
Y⁻ is an anion.

4. The composition of claim 2, wherein the dye has a structure according to Structure II 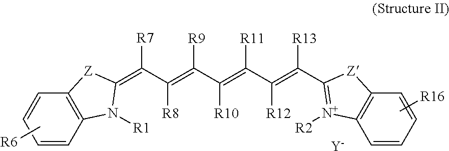
wherein R1 and R2 are independently selected alkyl groups having 1 to 18 carbon atoms;
Z and Z′ are independently selected from —O—, —S—, 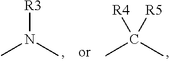
wherein R3, R4 and R5 are independently selected alkyl groups;
R7, R8, R9, R10, R11, R12 and R13 are independently selected from hydrogen, alkyl, amine, aryl, sulfone, triazole or halo;
R6 and R16 are independently selected from hydrogen, alkyl, alkenyl, aryl, fused aryl, halo, cyano, alkoxy, phenoxy, ester, amide, amine, nitrile, ketone, sulfide, sulfoxide, sulfone, sulfonate, sulfonamide, carboxylate nitro, or a polymeric moiety; and
Y⁻ is an anion.

5. The composition of claim 2, wherein the dye has a structure according to Structure III 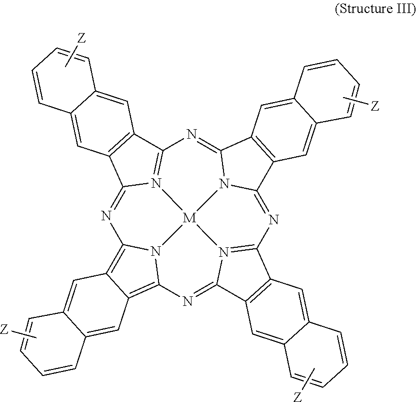
wherein Z is independently selected from hydrogen, alkyl, alkenyl, aryl, halo, cyano, alkoxy, aryloxy, ester, ether, amide, amine, cyano, ketone, sulfide, sulfoxide, sulfone, nitro, or a polymeric moiety;
at least one Z is other than hydrogen; and
M is 2H, vanadium oxide, zinc, aluminum chloride, silicon oxide, or magnesium.

6. The composition of claim 2, wherein the dye has a structure according to Structure IV 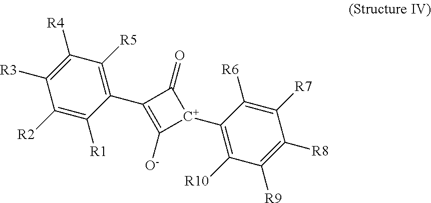
wherein R1, R2, R3, R4, R5, R6, R7, R8, R9 and R10 are independently selected from hydrogen, alkyl, aryl, heteroaryl, halogen, amino, mercapto, hydroxyl, aryloxy or alkoxy.

7. The composition of claim 2, wherein the dye has a structure according to Structure V 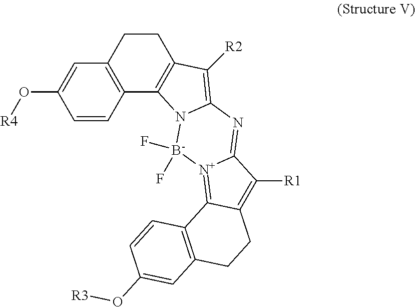
wherein R1 and R2 are independently selected aromatic rings; and
R3 and R4 are independently selected alkyl having 1 to 18 carbon atoms or aryl having 6 to 10 carbons.

8. The composition of claim 3 further including one or more dyes selected from: 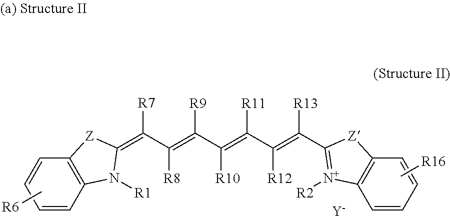
wherein R1 and R2 are independently selected alkyl groups having 1 to 18 carbon atoms;
Z and Z′ are independently selected from —O—, —S—, 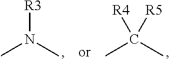
wherein R3, R4 and R5 are independently selected alkyl groups;
R7, R8, R9, R10, R11, R12 and R13 are independently selected from hydrogen, alkyl, amine, aryl, sulfone, triazole or halo;
R6 and R16 are independently selected from hydrogen, alkyl, alkenyl, aryl, fused aryl, halo, cyano, alkoxy, phenoxy, ester, amide, amine, nitrile, ketone, sulfide, sulfoxide, sulfone, sulfonate, sulfonamide, carboxylate nitro, or a polymeric moiety;
Y⁻is an anion;
and 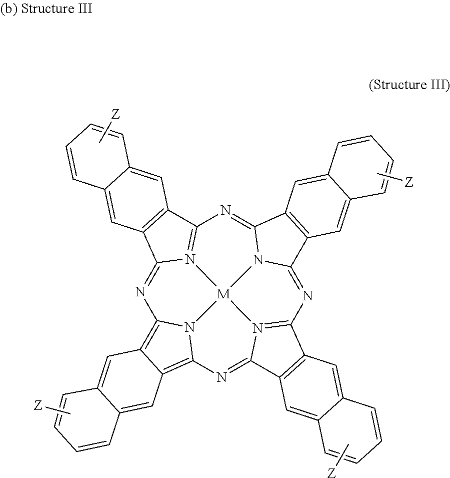
wherein Z is independently selected from hydrogen, alkyl, alkenyl, aryl, halo, cyano, alkoxy, aryloxy, ester, ether, amide, amine, cyano, ketone, sulfide, sulfoxide, sulfone, nitro, or a polymeric moiety;
at least one Z is other than hydrogen; and
M is 2H, vanadium oxide, zinc, aluminum chloride, silicon oxide, or magnesium.

9. The composition of claim 2 wherein the polyvinyl acetal is polyvinyl butyral.

10. The composition of claim 2 wherein the weight ratio of the dye relative to the combined weight of the dye and binder is in a range of 0.007 to 0.025.

11. The composition of claim 2 further including a hydroquinone derivative or ascorbic acid.
